(19) United States
(12) Patent Application Publication
(10) Pub. No.: US 2024/0064113 A1
(43) Pub. Date: Feb. 22, 2024

(54) INTELLIGENT SUBSCRIBER LINE DE-ASSIGNING FOR BANDWIDTH ALLOCATION MANAGEMENT

(71) Applicant: Charter Communications Operating, LLC, St. Louis, MO (US)

(72) Inventor: Deh-Min Wu, Centennial, CO (US)

(21) Appl. No.: 17/889,990

(22) Filed: Aug. 17, 2022

(51) Int. Cl. H04L 47/783

(52) U.S. Cl. CPC H04L 47/783

(57) ABSTRACT

Data indicative of a request to allocate an additional bandwidth amount to a subscriber line of a plurality of subscriber lines assigned to a network device is received. A sum of the additional bandwidth amount and an aggregate bandwidth amount that is currently allocated to the plurality of subscriber lines is determined to exceed a maximum bandwidth capacity of the network device. At least one criterion is evaluated to determine a value metric for each of the plurality of subscriber lines. A candidate subscriber line of the plurality of subscriber lines to de-assign from the network device based at least in part on the value metric for the candidate subscriber line and a current bandwidth allocated to the candidate subscriber line is identified.

### BACKGROUND

Generally, internet service providers (ISPs) allocate a certain quantity of bandwidth to a subscriber line (e.g., a data link used to facilitate internet services) based on a subscription tier of an associated subscriber. For example, an ISP may provide two subscription tiers: a first tier with a maximum bandwidth allocation of 1 Gigabit per second (Gbps), and a second tier with a maximum bandwidth allocation of 2 Gbps. Subscribers of the first tier can increase their maximum bandwidth allocation by requesting that their subscriber line be upgraded to the second tier. Specifically, once this request is submitted, a network device to which the subscriber line is assigned can receive the request and allocate the additional bandwidth to the subscriber line.

### SUMMARY

The examples implement mechanisms for intelligent subscriber line de-assigning for bandwidth allocation management. Data indicative of a request to allocate an additional bandwidth amount to a subscriber line of a plurality of subscriber lines assigned to a network device (e.g., a 10G port, etc.) can be received. A sum of the additional bandwidth amount and an aggregate bandwidth amount that is currently allocated to the plurality of subscriber lines can be determined to exceed a maximum bandwidth capacity of the network device. At least one criterion is evaluated to determine a value metric for each of the plurality of subscriber lines. A candidate subscriber line of the plurality of subscriber lines can be identified to de-assign from the network device based at least in part on the value metric for the candidate subscriber line and the current bandwidth allocated to the candidate subscriber line.

In one example a method is provided. The method includes receiving, by a computing system comprising one or more processor devices, data indicative of a request to allocate an additional bandwidth amount to a subscriber line of a plurality of subscriber lines assigned to a network device. The method includes determining, by the computing system, that a sum of the additional bandwidth amount and an aggregate bandwidth amount that is currently allocated to the plurality of subscriber lines exceeds a maximum bandwidth capacity of the network device. The method includes evaluating at least one criterion to determine a value metric for each of the plurality of subscriber lines. The method includes identifying a candidate subscriber line of the plurality of subscriber lines to de-assign from the network device based at least in part on the value metric for the candidate subscriber line and a current bandwidth allocated to the candidate subscriber line.

In another example, a computing system is provided. The computing system includes memory. The computing system includes one or more processor devices coupled to the memory. The one or more processors are to receive data indicative of a request to allocate an additional bandwidth amount to a subscriber line of a plurality of subscriber lines assigned to a network device. The one or more processors are to determine that a sum of the additional bandwidth amount and an aggregate bandwidth amount that is currently allocated to the plurality of subscriber lines exceeds a maximum bandwidth capacity of the network device. The one or more processors are to evaluate at least one criterion to determine a value metric for each of the plurality of subscriber lines. The one or more processors are to identify a candidate subscriber line of the plurality of subscriber lines to de-assign from the network device based at least in part on the value metric for the candidate subscriber line and a current bandwidth allocated to the candidate subscriber line.

In yet another example, a non-transitory computer-readable storage medium is provided. The non-transitory computer-readable storage medium includes executable instructions. The executable instructions are to cause a processor device to receive data indicative of a request to allocate an additional bandwidth amount to a subscriber line of a plurality of subscriber lines assigned to a network device. The executable instructions are to cause a processor device to determine that a sum of the additional bandwidth amount and an aggregate bandwidth amount that is currently allocated to the plurality of subscriber lines exceeds a maximum bandwidth capacity of the network device. The executable instructions are to cause a processor device to evaluate at least one criterion to determine a value metric for each of the plurality of subscriber lines. The executable instructions are to cause a processor device to identify a candidate subscriber line of the plurality of subscriber lines to de-assign from the network device based at least in part on the value metric for the candidate subscriber line and a current bandwidth allocated to the candidate subscriber line.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for intelligent subscriber line de-assigning for bandwidth allocation management according to some implementations of the present disclosure.

FIG. 2 is a flowchart of a method for intelligent subscriber line de-assigning for bandwidth allocation according to some implementations of the present disclosure.

FIG. 3A illustrates a network layout for evaluation of a distance criterion at a first time T1 according to some implementations of the present disclosure.

FIG. 3B illustrates a network layout for evaluation of a distance criterion at a second time T2 according to some implementations of the present disclosure.

FIG. 4 illustrates geolocation information that depicts a map of a geographic region for evaluation of a location criterion according to some implementations of the present disclosure.

FIG. 5 illustrates infrastructure information that indicates additional network infrastructure for evaluation of an infrastructure criterion according to some implementations of the present disclosure.

FIG. 6 is a block diagram of the source computing system suitable for implementing examples according to some implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Internet service providers (ISPs) generally provide internet services that facilitate the flow of data to and from a subscriber (e.g., a residence, a place of business, wireless device(s), etc.) via a subscriber line (e.g., Coaxial cable(s), fiber-optic cable(s), a wireless connection, etc.). Many ISPs limit the maximum bandwidth of subscriber lines based on an internet service tier selected by the subscribers. For example, the ISP may assign multiple subscriber lines to one of many network devices (e.g., network device(s), virtualized network device(s), a computing system associated with the ISP, etc.) included in a network of the ISP. Based on the internet service tier selected for each subscriber line, the network device can allocate a maximum bandwidth to each of the subscriber lines up to a maximum bandwidth capacity of the network device.

As an example, the ISP may offer three internet service tiers: a first tier with a maximum bandwidth of 500 Megabits per second (Mbps), a second tier with a maximum bandwidth of 1 Gigabit per second (Gbps), and a third tier with a maximum bandwidth of 2 Gbps. A current subscriber who has selected the second tier will have a subscriber line that is limited to a maximum bandwidth of 1 Gbps. If the current subscriber wishes to increase the maximum bandwidth of their subscriber line, the current subscriber may submit a request to the ISP to allocate an additional bandwidth amount to their subscriber line (i.e., a request that the current subscriber's internet service be upgraded to the third tier). In response, a network device to which the subscriber line of the current subscriber is assigned can increase the bandwidth allocated to the subscriber line from 1 Gbps to 2 Gbps.

However, the bandwidth allocated by the network device should not exceed the maximum bandwidth capacity of the network device. To follow the previous example, the network device to which the subscriber line is assigned can have a maximum bandwidth capacity of 10 Gbps (e.g., a 10G Optical Line Terminal (OLT) port, etc.). Prior to receiving the request to allocate the additional bandwidth amount to the subscriber line, the network device may be collectively allocating an aggregate bandwidth amount of 10 Gbps to the current subscriber line and a number of other subscriber lines. As such, the sum of the additional bandwidth amount requested by the current subscriber and the aggregate bandwidth amount currently allocated to the subscriber lines (e.g., 11 Gbps) would exceed the maximum bandwidth capacity of the network device (e.g., 10 Gbps).

Accordingly, implementations of the present disclosure propose intelligent subscriber line de-assigning for bandwidth allocation management. Specifically, if the sum of the additional bandwidth amount and an aggregate bandwidth amount currently allocated to a plurality of subscriber lines exceeds the maximum bandwidth capacity of the network device, implementations of the present disclosure can evaluate criterion(s) (e.g., locations of the subscriber lines, geographic areas of the subscriber lines, infrastructure serving the subscriber lines, etc.) to determine candidate subscriber line(s) that are optimal to de-assign from the network device, therefore providing bandwidth capacity to the network device sufficient to fulfill the request for additional bandwidth.

As an example, a computing system associated with an ISP can receive a request to allocate 1 Gbps of additional bandwidth from a subscriber line of a plurality of subscriber lines assigned to a network device with a maximum bandwidth capacity of 10 Gbps. The computing system can determine that the sum of the request for additional bandwidth and the aggregate bandwidth amount currently allocated to the plurality of subscriber lines (e.g., 10 Gbps+1 Gbps=11 Gbps) exceeds the maximum bandwidth capacity of the network device (e.g., 10 Gbps).

The computing system can evaluate criterion(s) to determine a value metric for each of the plurality of subscriber lines. For example, the criterion may be an infrastructure criterion, and the computing system can evaluate the infrastructure criterion to determine that one of the subscriber lines (e.g., the bandwidth-requesting subscriber line, a non-requesting subscriber line, etc.) is closest to some other network device that currently has available bandwidth capacity. Based on the value metrics, and a current bandwidth allocated to each subscriber line, the computing system can identify a candidate subscriber line to de-assign from the network device. To follow the previous example, the subscriber line closest to the other network device may be identified as the candidate subscriber line, and can be de-assigned from the network device and re-assigned to the other network device that has available bandwidth capacity. In such fashion, implementations of the present disclosure can intelligently de-assign subscriber lines to manage bandwidth allocation within a network.

Aspects of the present disclosure provide a number of technical effects and benefits. As one example technical effect and benefit, allocating more bandwidth than a maximum bandwidth capacity of a network device can cause serious performance degradation for some, or all, subscriber lines assigned to the network device (e.g., packet loss, reduced bandwidth, connection instability, etc.). However, by intelligently de-assigning subscriber line(s) from the network device, implementations of the present disclosure can facilitate completion of requests for additional bandwidth while eliminating any performance loss associated with exceeding the maximum bandwidth capacity of the network device.

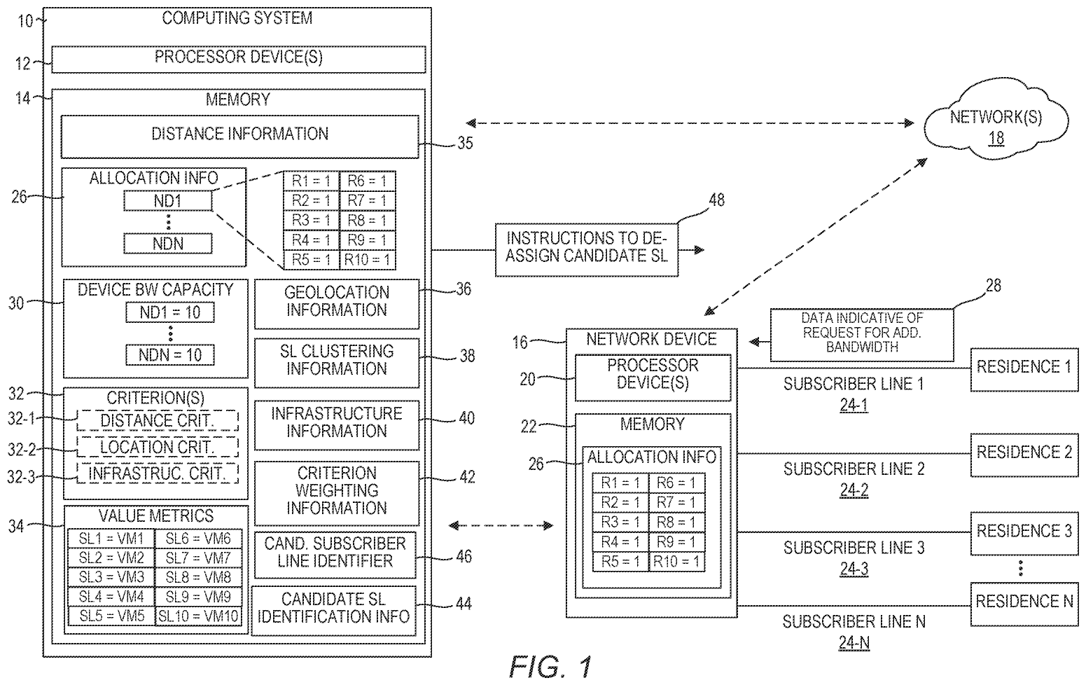

FIG. 1 is a block diagram of an environment suitable for intelligent subscriber line de-assigning for bandwidth allocation management according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. In some implementations, the computing system 10 may include computing device(s) configured to facilitate network operations for a network of a service provider (e.g., an internet service provider (ISP), etc.). Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.).

The computing system 10 can include, or can be communicatively coupled with, a network device 16. For example, the computing system 10 can be a computing system associated with a service provider, such as an internet service provider, mobile network service provider, wireless service provider, etc.). The network device 16 can be a device that facilitates provision of services to subscribers that subscribe to services provided by the service provider. For example, the network device 16 may be a port (e.g., an Optical Line Terminal (OLT) 10G port, etc.), a switch, etc.). For example, the network device 16 may be a Cable Modem Termination System (CMTS)/Hybrid Fiber Coaxial (HFC) network port. In some implementations, computing system 10 may include the network device 16. Alternatively, in some implementations, the computing system may be communicatively coupled to the network device 16. For example, the computing system 10 may communicate with the network device 16 via network(s) 18 (e.g., via a wired connection, wireless connection, etc.).

Alternatively, in some implementations, the network device 16 may be a virtualized network device. For example, the network device 16 may be software instructions stored in the memory 14 of the computing system 10 that program the processor device(s) 12 of computing system 10 to implement the functionality of the network device 16. For another example, the network device 16 may be a virtualized network device executed by other processor device(s) included in the network(s) 18 of the service provider.

The network device 16 can include processor device(s) 20 and memory 22. The processor device(s) 20 can be processor device(s) as previously described with regards to processor device(s) 12. Similarly, the memory 22 can be a memory as previously described with regards to memory 14.

The network device 16 can be utilized to provide services to subscribers that subscribe to services of the service provider. Specifically, the network device 16 can allocate a maximum bandwidth to subscriber lines associated with subscribers for internet services (e.g., wired internet services, wireless internet services, etc.). For example, multiple subscribers can subscribe to internet services provided by an ISP. These internet services can be provided via subscriber lines 24. A subscriber line 24 can be any sort of physical or virtual data link (e.g., a fiber-optic cable, a coaxial cable, a wireless connection, etc.) between the network device 16 and a residence associated with the subscriber. These subscriber lines 24 can travel from the network device 16 to a residence associated with the subscriber, at which the subscriber line 24 terminates. (e.g., a home or apartment of the subscriber, a business of the subscriber, a wireless device of the subscriber, a vehicle of the subscriber, etc.).

Each subscriber line 24 can be assigned to the network device 16. For example, in some implementations, the computing system 10 may dynamically assign and de-assign subscriber lines to and from the network device 16 to facilitate network operations for the internet service provider. Alternatively, in some implementations, the network device 16 may determine the allocation information 26. Alternatively, in some implementations, the network device 16 may be provided with the allocation information 26 via some other computing device(s) associated with the ISP (e.g., via the network(s) 18).

The network device 16 can allocate a bandwidth amount to each subscriber line 24 that is assigned to the network device 16. A bandwidth amount can refer to a maximum quantity of data per second that can be downloaded and/or uploaded over a subscriber line 24. For example, in some implementations, the network device 16 may allocate a bandwidth amount to the subscriber lines 24 based on allocation information 26. In some implementations, the allocation information 26 may be stored in the memory 22 of the network device 16. Alternatively, in some implementations, the allocation information 26 may be stored in the memory 14 of the computing system 10, where it can be accessed by the network device 16 (e.g., via the network(s) 18).

The allocation information 26 can indicate a bandwidth amount allocated to each subscriber line 24 assigned to the network device 16. For example, the allocation information 26 may indicate that subscriber line 24-1 is to be allocated a bandwidth amount of 1 Gbps while subscriber line 24-2 is to be allocated a bandwidth amount of 2 Gbps. In some implementations, the amount of bandwidth indicated by the allocation information 26 is determined based on a subscription tier associated with the subscriber line. For example, the ISP may offer two internet service tiers: a first tier with a maximum bandwidth of Gbps and a second tier with a maximum bandwidth of 2 Gbps. If the subscriber associated with subscriber line 24-1 has selected the first tier of service from the ISP, the allocation information 26 can indicate that the subscriber line 24-1 is to be allocated 1 Gbps of bandwidth. If the subscriber associated with subscriber line 24-2 has selected the second tier of service from the ISP, the allocation information 26 can indicate that the subscriber line 24-2 is to be allocated 2 Gbps of bandwidth.

Often, subscribers desire to increase their subscription tier with ISPs to increase the amount of bandwidth allocated to their associated subscriber line. To follow the previous example, the subscriber associated with subscriber line 24-1, which is allocated 1 Gbps, may desire to upgrade their subscription from the first tier to the second tier (e.g., from 1 Gbps to 2 Gbps). To do so, the subscriber associated with subscriber line 24-1 can provide data indicative of a request for additional bandwidth 28. Specifically, the data indicative of a request for additional bandwidth 28 can indicate a request to allocate an additional bandwidth amount to the subscriber line 24-1.

In some implementations, the network device 16 can receive the data indicative of a request for additional bandwidth 28. For example, the subscriber associated with the subscriber line 24-1 may directly provide the data indicative of a request for additional bandwidth 28 via an application associated with the ISP. Alternatively, in some implementations, the data indicative of a request for additional bandwidth 28 may be received from the computing system 10. Specifically, the data indicative of a request for additional bandwidth 28 can be provided to the computing system 10 via the network(s) 18 (e.g., by other ISP computing device(s), by a computing device of the subscriber, etc.).

The network device 16 has a maximum bandwidth capacity that determines a maximum amount of bandwidth that the network device 16 can allocate to subscriber lines. For example, if the network device 16 has a maximum bandwidth capacity of 10 Gbps, the network device 16 can provide an aggregated total of 10 Gbps to subscriber lines 24 (e.g., 2 Gbps to five subscriber lines, 1 Gbps to 10 subscriber lines, 5 Gbps to 2 subscriber lines, etc.). However, if the network device 16 has already allocated its maximum bandwidth capacity to the subscriber lines 24, the data indicative of a request for additional bandwidth 28 may exceed the maximum bandwidth capacity of the network device 16.

Specifically, the computing system can determine that a sum of the requested additional amount of bandwidth requested and the aggregate bandwidth amount that is currently allocated to the subscriber lines 24 exceeds the maximum bandwidth capacity of the network device 16. In some implementations, the computing system can determine that the sum exceeds the maximum bandwidth capacity of the network device 16 based on device maximum bandwidth capacity information 30. For example, the memory 14 of the computing system 10 may include the device maximum bandwidth capacity information 30. The device maximum bandwidth capacity information 30 may indicate a maximum bandwidth capacity of multiple network devices associated with the ISP. For example, the device maximum bandwidth capacity information may indicate that the network device 16 has a maximum bandwidth capacity of 10 Gbps, and may indicate that a different network device has a maximum bandwidth capacity of 25 Gbps.

The computing system 10 can evaluate at least one criterion 32 to determine a value metric 34 for each of the subscriber lines 24. The criterion(s) 32 can include any criterion that may be evaluated to determine a value metric 34 for a subscriber line 24. The value metrics 34 can indicate a value associated with de-assignment of a subscriber line relative to other subscriber lines of the subscriber lines 24. For example, the criterion(s) 32 may be evaluated to determine a value metric of 7.5 for the subscriber line 24-1 and a value metric of 5.3 for the subscriber line 24-1. The computing system 10 may determine to begin de-assigning subscriber lines 24 starting with the subscriber lines with the highest (or lowest) value metrics.

For example, in some implementations, the criterion(s) 32 may include a distance criterion 32-1. To evaluate the distance criterion 32-1, the computing system 10 can determine a distance between each of the subscriber lines 24. The memory 14 computing system 10 may include distance information 35. In some implementations, the computing system 10 can determine the distance between each subscriber line 24 based on the distance information 35. For example, the computing system 10 can determine the distances between each of the subscriber lines 24 and store the distances as a graph in distance information 35.

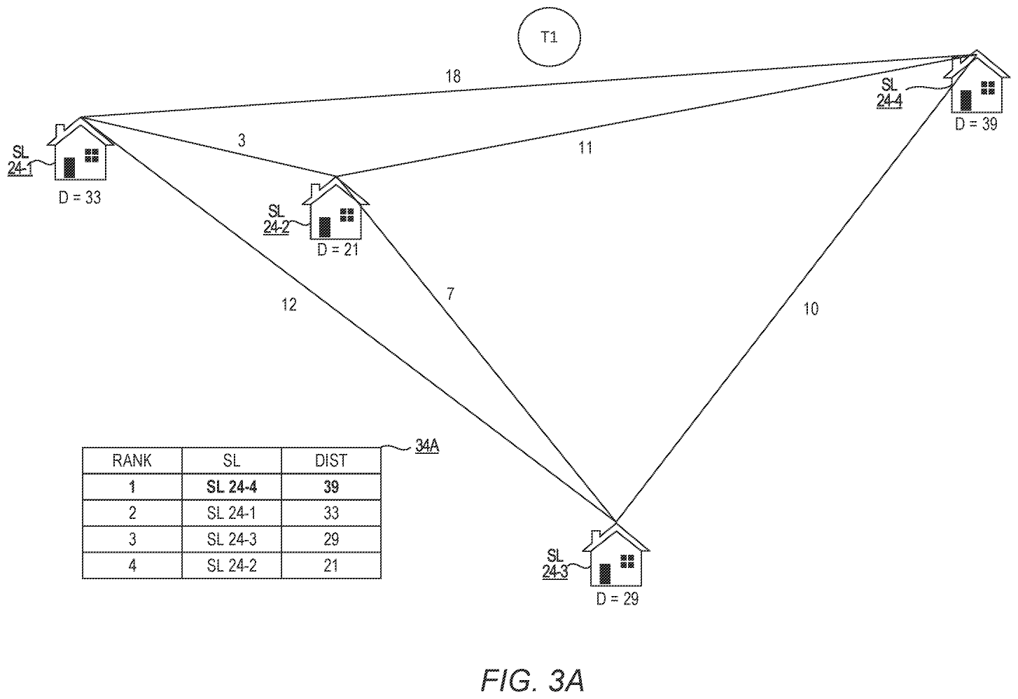

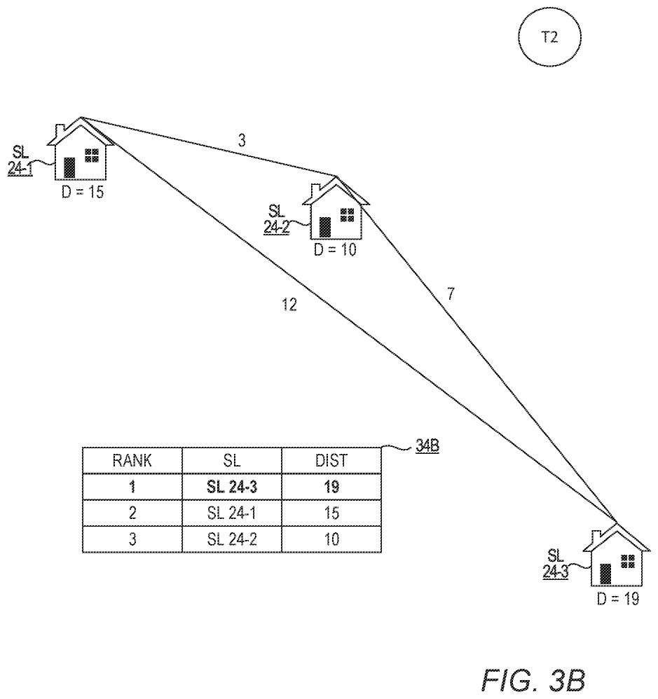

Based on the distance between each of the subscriber lines 24, the computing system 10 can determine the value metrics 34 for each of the subscriber lines 24. For example, in some implementations, the value metrics 34 of a group of subscriber lines 24 that are close to each other may be relatively low, while the value metric 34 for a subscriber line 24 that is far away from the group of subscriber lines may be relatively high. Evaluation of the distance criterion 32-1 will be discussed in greater detail with regards to FIGS. 3A-3B.

Additionally, or alternatively, in some implementations, the criterion(s) 32 can include a location criterion 32-2. To evaluate the location criterion 32-2, the computing system 10 can obtain geolocation information 36. The geolocation information 36 can describe a location, or geographic zone, of each of the subscriber lines 24, or may describe the locations or geographic zones of the subscribers associated with the subscriber lines 24 Specifically, the geolocation information 36 can describe the location of a subscriber line 24 to any degree of specificity. For example, the geolocation location information may describe the address, city, county, country, building, time zone, etc. at which a subscriber line 24, or a subscriber associated with the subscriber line 24, is located.

Based on the geolocation information 36, the computing system 10 can group subscriber lines 24 into a plurality of location clusters. The plurality of location clusters can be stored by the computing system 10 as subscriber line clustering information 38. For example, subscriber lines 24-1, 24-2, and 24-3 may each be located within a first county. Subscriber lines 24-4, 24-5, and 24-6 may be located in a county different than the first county. The computing system can group the subscriber lines 24-1, 24-2, and 24-3 into a first location cluster and the subscriber lines 24-4, 24-5, and 24-6 into a second location cluster. The first and second location clusters can be stored in the subscriber line clustering information 38.

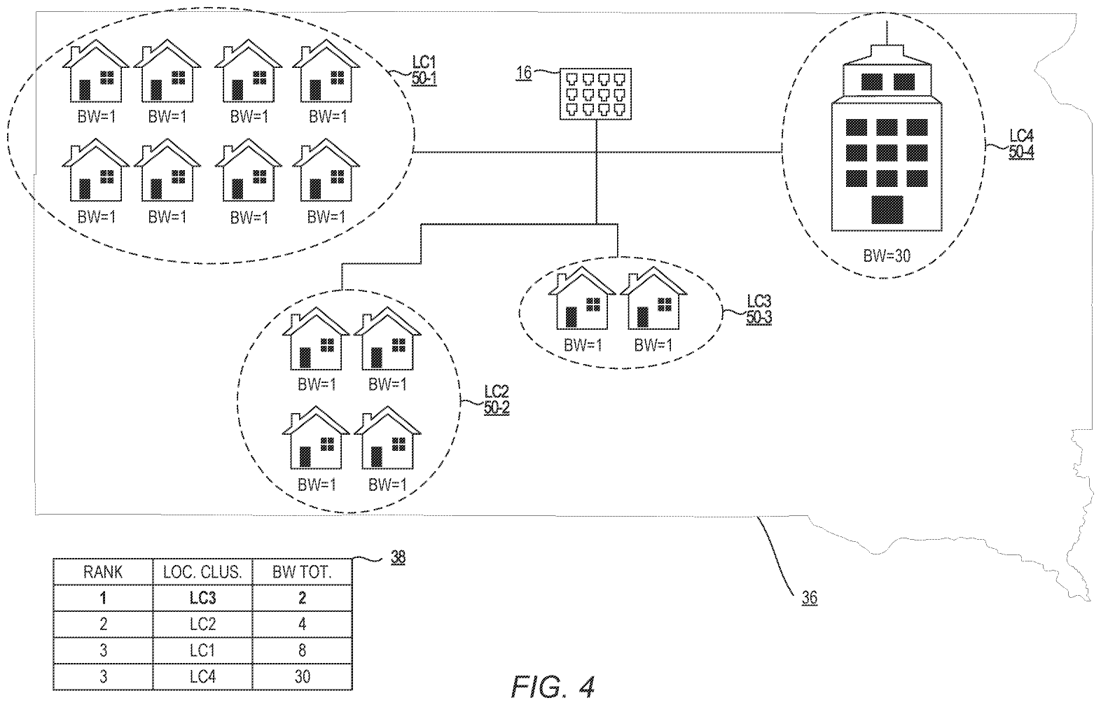

Additionally, the subscriber line clustering information 38 can indicate a bandwidth allocated to each location cluster of the plurality of location clusters. To follow the previous example, subscriber lines 24-1, 24-2, and 24-3 may each be allocated 1 Gbps of bandwidth. Subscriber lines 24-4, 24-5, and 24-6 may each be allocated 2 Gbps of bandwidth. The subscriber line clustering information 38 can indicate that the first location cluster is collectively allocated 3 Gbps of bandwidth while the second location cluster is collectively allocated 6 Gbps of bandwidth. Based on the bandwidth collectively allocated to each location cluster, the computing system 10 can determine the value metrics 34 for the subscriber lines 24. Evaluation of the location criterion will be discussed in greater detail with regards to FIG. 4.

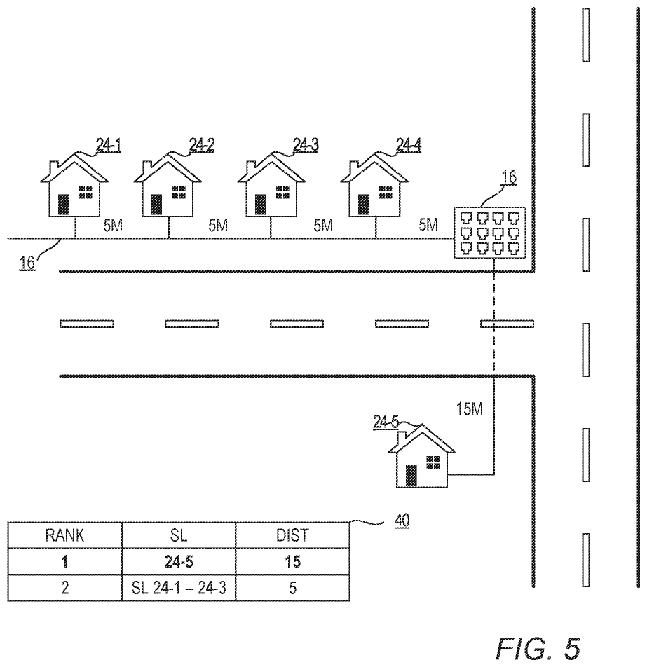

Additionally, or alternatively, in some implementations, the criterion(s) can include an infrastructure criterion 32-3. To evaluate the infrastructure criterion 34-3, the computing system 10 can obtain network infrastructure information 40. The network infrastructure information can describe various network infrastructure shared between the subscriber lines 24. For example, one network infrastructure entity (e.g., a pipe used to deliver subscriber lines to residences, etc.) may be shared by subscriber lines 24-1 and 24-2, while another network infrastructure entity (e.g., an amplifier, a wireless receiver, etc.) may be shared by subscriber lines 24-3 and 24-4. Evaluation of the infrastructure criterion 32-3 will be discussed in greater detail with regards to FIG. 5.

In some implementations, to evaluate the criterion(s) 32, the computing system 10 may weight each of the criterion(s) 32. Specifically, the computing system 10 may determine criterion weighting information 42, which can be utilized to weight each criterion 32 when evaluating the criterion(s) 32. For example, in some implementations the criterion(s) 32 can include a plurality of criterions 32. The computing system 10 can apply weights (e.g., criterion weighting information 42, etc.) to the plurality of criterions 32 to obtain a plurality of weighted criterions. The computing system can evaluate the plurality of weighted criterions to determine the value metrics 34 for each of the plurality of subscriber lines 24.

In some implementations, prior to applying the weights to the plurality of criterions 32, the computing system 10 can determine the weights that are stored in the criterion weighting information 42. In some implementations the computing system 10 can determine the criterion weighting information 42 (e.g., the weights) based on a population density of a geographic region that includes the network device 16. For example, the network device 16 may be located in a geographic region with a high population density, such as a large city, or a densely populated suburb. When the network device 16 is located in a geographic region with a high population density, the location criterion 32-2 is of particular importance, as the subscriber lines 24 can be grouped into location clusters with a high degree of specificity in the subscriber line clustering information 38 (e.g., can be grouped by building, city block, floors of a building, etc.). Due to the network device 16's location in the highly populated geographic area, the computing system 10 may determine a relatively high weight for application to the location criterion 32-2 during evaluation of the criterion(s) 32.

For another example, the network device 16 may be located in a sparsely populated area, such as a rural area, or an island. When the network device 16 is located in a geographic region with a sparse population density, the location criterion 32-2 is not of particular importance, as the subscriber lines 24 can only be grouped into location clusters with a low degree of specificity in the subscriber line clustering information 38 (e.g., can only be grouped collectively as a whole town, island, county, etc.). Due to the network device 16's location in the sparsely populated geographic area, the computing system 10 may determine a relatively low weight for application to the location criterion 32-2 during evaluation of the criterion(s) 32.

Additionally, or alternatively, in some implementations, the computing system 10 can determine the weights of the criterion weighting information 42 based on a degree of infrastructure availability within a network that includes the network device 16. For example, the infrastructure criterion 32-3 is evaluated based at least in part on a current degree of available infrastructure that may be used by subscriber lines 24 the network device 16 (e.g., other network devices close to the network device 16, etc.). If the network has a high degree of available infrastructure that can also be used serve the subscriber lines 24, it is likely that any of the subscriber lines 24 can easily be served after de-assignment from the network device 16. As such, the computing system 10 may determine a relatively low weight for application to the infrastructure criterion 32-3 during evaluation of the criterion(s) 32. Alternatively, if the network has a low degree of available infrastructure that can also be used serve the subscriber lines 24, it is likely that only one, or some, of the subscriber lines 24 can be served after de-assignment from the network device 16. As such, the computing system 10 may determine a relatively high weight for application to the infrastructure criterion 32-3 during evaluation of the criterion(s) 32.

Additionally, or alternatively, in some implementations, the computing system 10 can determine the criterion weighting information 42 (e.g., the weights) based on a current layout of subscriber lines within the network. For example, the network may have a subscriber line layout such that each of the subscriber lines 24 are within similar distances of each other (e.g., subscriber residences distributed in a uniform pattern in a suburb, etc.). As the differences in location between the subscriber lines 24 are minimal, the computing system 10 may determine a relatively low weight for application to the distance criterion 32-1 during evaluation of the criterion(s) 32. For another example, the network may have a subscriber line layout such that each of the subscriber lines 24 are within very different distances of each other (e.g., a mixed area that includes a uniformly distributed suburb and rural subscriber residences located distantly from the suburb, etc.). As the differences in location between the subscriber lines 24 are high, the computing system 10 may determine a relatively high weight for application to the distance criterion 32-1 during evaluation of the criterion(s) 32.

Based on the at least one criterion 32, and a current bandwidth allocated to each of the subscriber lines 24, the computing system 10 can identify a candidate subscriber line to de-assign from the network device 16. Specifically, the computing system 10 can determine candidate subscriber line identification information 44 that identifies the candidate subscriber line using the subscriber line identifier 46. The subscriber line identifier 46 can be any sort of module, application, hardware, and/or collection of software instructions configured to identify a candidate subscriber line from the subscriber lines 24.

For example, the computing system 10 may evaluate the distance criterion 32-1 for each of the subscriber lines 24. The subscriber line 24-1 can have the highest associated value metric from evaluation of the distance criterion 32-1. Based on the distance criterion 32-1, the computing system 10 can identify the subscriber line 24-1 as the candidate subscriber line for de-assignment from the network device 16 using the candidate subscriber line identifier 46, and can store the identification as candidate subscriber line identification information 44. For another example, the computing system 10 may evaluate the criterion(s) 32 to determine a value metric of 8.0 for subscriber line 24-1 and a value metric of 7.8 for subscriber line 24-2. Subscriber line 24-1 can have a current bandwidth allocation of 1 Gbps and subscriber line 24-2 can have a current bandwidth of 2 Gbps. Although subscriber line 24-1 has a higher associated value metric, the value metrics of both subscriber lines 24-1 and 24-2 are relatively close, and subscriber line 24-2 has twice the current bandwidth allocation as subscriber line 24-1. As such, although subscriber line 24-1 has the highest value metric, the computing system 10 may identify subscriber line 24-2 as the candidate subscriber line for de-assignment from the network device 16.

As another example, the subscriber lines 24 may be located in a densely populated area. The computing system 10 may evaluate criterions 32-1 and 32-2. When evaluating location criterion 32-2, the computing system 10 may group subscriber lines 24-1 and 24-2 in a location cluster stored in the subscriber line clustering information 38. Based on the location criterion 32-2, the computing system 10 may identify the location cluster that includes subscriber lines 24-1 and 24-2 as the candidate subscriber line. Specifically, the computing system 10 may identify both subscriber line 24-1 and subscriber line 24-2 as candidate subscriber lines due to their inclusion within the same location cluster. However, it should be noted that each subscriber line in a location cluster is not required to be selected as a candidate subscriber line. To follow the previous example, the computing system 10 may also evaluate the distance criterion 32-1 and may assign a high value metric to subscriber line 24-1 and a low value metric to subscriber line 24-2. As such, if the distance criterion 32-1 is not weighted relatively low, the computing system 10 may only select subscriber line 24-1 as the candidate subscriber line, even if subscriber line 24-2 is part of the same location cluster.

In some implementations, the computing system 10 can de-assign the candidate subscriber line from the network device 16. For example, based on the candidate subscriber line identification information 44, which identifies the candidate subscriber line, the computing system 10 can generate instructions to de-assign the candidate subscriber line 48. In some implementations, the instructions to de-assign the candidate subscriber line 48 can be provided to the network device 16, which can de-assign the candidate subscriber line. For example, if the candidate subscriber line is subscriber line 24-1, the network device 16 may remove the entry associated with the subscriber line 24-1 from the allocation information 26. Additionally, or alternatively, in some implementations the computing system 10 may remove the entry associated with subscriber line 24-1 from the allocation information 26 stored in the memory 14 of the computing system 10, and/or the allocation information 26 stored in the memory 22 of the network device 16.

Alternatively, in some implementations, the computing system 10 may provide the instructions to de-assign the candidate subscriber line 48 to some other network entity associated with the ISP (e.g., via network(s) 18).

In some implementations, the instructions to de-assign the candidate subscriber line 48 can be provided to the network device 16 via an Application Programming Interface (API). The network device 16 may be configured to communicate via a RESTful API. The computing system 10 can format the instructions to de-assign the candidate subscriber line 48 for submission via the API. As a non-limiting example, the instructions to de-assign the candidate subscriber line 48 may be JSON data that identifies the candidate subscriber line.

In some implementations, the instructions to de-assign the candidate subscriber line 48 can be a series of instructions that instructs the network device 16 to perform a series of actions in order that are collectively configured to de-assign the candidate subscriber line from the network device 16. For example, the instructions to de-assign the candidate subscriber line 48 may include instructions to the network device 16 to:
Delete services associated with the subscriber (e.g., television services, internet services, phone services, etc.).
Delete the Cable Modem (CM)/Optical Network Terminal (ONT)/5G-RG (Fifth Generation Residential Gateway) interface (e.g., Gigabit ethernet, etc.)
Delete the subscriber associated with the subscriber line (e.g., a subscriber “John Smith”, etc.).
Delete any CM/ONT device(s) belonging to the subscriber.
Delete the OLT interface towards the CM/ONT.

In some implementations, the computing system 10 can modify the bandwidth amount currently allocated to the subscriber line (e.g., the requesting subscriber line) of the plurality of subscriber lines 24 based on the additional bandwidth amount requested by the subscriber line. For example, if the requesting subscriber line is subscriber line 24-1, the network device 16 may modify the entry associated with the subscriber line 24-1 in the allocation information 26 (e.g., modifying R1=1 to be R1=(2), etc.). Additionally, or alternatively, in some implementations the computing system 10 may modify the entry associated with subscriber line 24-1 in the allocation information 26 stored in the memory 14 of the computing system 10, and/or the allocation information 26 stored in the memory 22 of the network device 16.

In some implementations, the computing system 10 may perform the processes described above to identify another candidate subscriber line from the subscriber lines 24. For example, the network device 16 may have a maximum bandwidth capacity of 10 Gbps, and may be currently allocating an aggregated Gbps of bandwidth to subscriber lines 24. The subscriber line 24-1 may have a current bandwidth allocation of 1 Gbps, and may request 4 Gbps of additional bandwidth allocation for a total bandwidth allocation of 5 Gbps. In response, the computing system may identify subscriber line 24-2, which can have a current bandwidth allocation of 1 Gbps, as the candidate subscriber line to be de-assigned from the network device 16. The computing system 10 can provide instructions to de-assign the candidate subscriber line 48 to the network device 16. However, the sum of the aggregate bandwidth amount currently allocated (e.g., 9 Gbps) and the additional bandwidth amount requested by the requesting subscriber line (e.g., 4 Gbps) still exceeds the maximum bandwidth capacity of the network device 16 (e.g., 10 Gbps). As such, the computing system can perform the previously described operations to identify a second candidate subscriber line from the subscriber lines 24 for de-assignment from the network device 16.

It should be noted that, in some implementations, the computing system 10 can evaluate the criterion(s) 32 for a second time when selecting the second candidate subscriber line. Specifically, due to the de-assignment of the first candidate subscriber line from the network device 16, the value metrics 34 resulting from the evaluation of the criterion(s) 32 may be different than when evaluated before de-assignment of the first candidate subscriber line. Alternatively, in some implementations, the computing system may rank each of the subscriber lines 24 based on their associated value metrics 34 before identification of the first candidate subscriber line, and may then simply identify the next highest ranked subscriber lines 24 as candidate subscriber lines until the additional amount of requested bandwidth does not exceed the maximum bandwidth capacity of the network device 16.

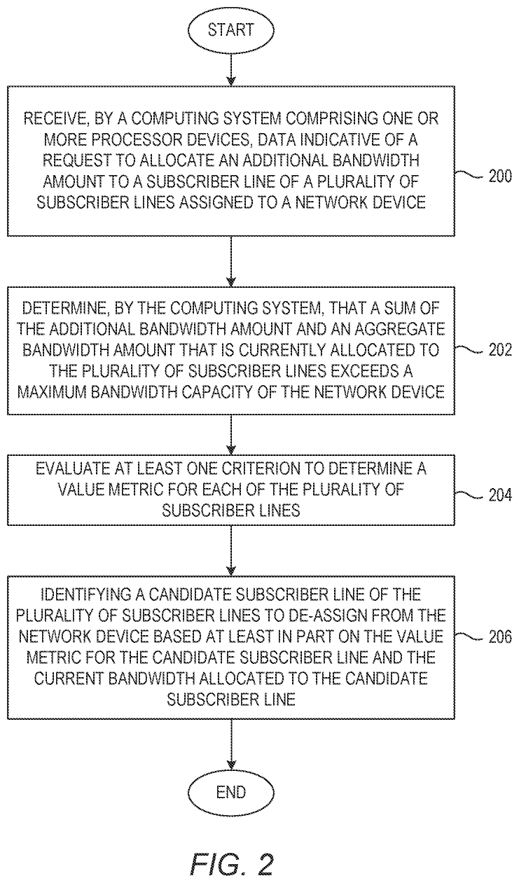

FIG. 2 is a flowchart of a method for intelligent subscriber line de-assigning for bandwidth allocation according to some implementations of the present disclosure. FIG. 2 will be discussed in conjunction with FIG. 1.

The computing system 10 receives the data indicative of the request 28 to allocate the additional bandwidth amount to the subscriber line of the plurality of subscriber lines 24 (FIG. 2, block 200). The computing system 10 determines that the sum of the additional bandwidth amount and the aggregate bandwidth amount that is currently allocated to the plurality of subscriber lines 24 exceeds a maximum bandwidth capacity 30 of the network device 16 (FIG. 2, block 202). The computing system 10 evaluates at least one criterion 32 to determine a value metric 34 for each of the plurality of subscriber lines 24 (FIG. 2, block 204). The computing system 10 identifies a candidate subscriber line of the plurality of subscriber lines 24 to de-assign from the network device 16 based at least in prat on the value metric 34 for the candidate subscriber line and the current bandwidth allocated to the candidate subscriber line (FIG. 2, block 206).

FIG. 3A illustrates a network layout for evaluation of a distance criterion at a first time T1 according to some implementations of the present disclosure. As depicted, subscriber lines 24-1, 24-2, 24-3, and 24-4 are included in the network layout, and are each located within certain distances of each other. Specifically, the distance information 35 stores an aggregated distance metric for each of the subscriber lines 24-1, 24-2, 24-3, and 24-4. The aggregated distance metric indicates an aggregated distance of a subscriber line from each other subscriber line served by the network device 16. For example, subscriber lines 24-1-24-4 are each served by the network device 16. Subscriber line 24-1 is 3 miles away from subscriber line 24-2, 12 miles away from subscriber line 24-3, and 18 miles away from subscriber line 24-4, providing an aggregated distance metric of 33 (e.g., 3+12+18=24). Subscriber line 24-2 has an aggregated distance metric of 21, subscriber line 24-3 has an aggregated distance metric of 29, and subscriber line 24-4 has an aggregated distance metric of 39.

The computing system 10 can determine the aggregated distance metrics for the subscriber lines 24-1-24-4 and can store the aggregated distance metrics in the distance information 34A, as described previously with regards to FIG. 1. Once the aggregated distance metrics are determined for each subscriber line, the aggregated distance metrics can be ranked in the distance information 34A. Based on the ranking, the computing system 10 can identify a subscriber line as a candidate subscriber line for de-assignment. For example, as candidate subscriber line 24-4 has the highest aggregated distance metric, the computing system 10 may identify subscriber line 24-4 as the candidate subscriber line.

FIG. 3B illustrates a network layout for evaluation of a distance criterion at a second time T2 according to some implementations of the present disclosure. As depicted, time T2 occurs after subscriber line 24-4 has been de-assigned from the network device to which subscriber lines 24-1-24-3 are still assigned. It can be assumed that the aggregate bandwidth currently allocated to subscriber lines 24-1-24-3 still exceeds the maximum bandwidth capacity of the network device 16 after de-assignment of subscriber line 24-4. The aggregate distance metrics for subscriber lines 24-1-24-3 can be determined and stored in the distance information 34B.

However, as depicted, the ranking of subscriber lines 24 in the distance information 34B at time T2 is different than the ranking in the distance information 34A at time T1 due to de-assignment of the subscriber line 24-4 from the network device 16. For example, at time T1, the subscriber line 24-1 is ranked higher (e.g., rank 2) than the subscriber line 24-3 (e.g., rank 3). Subscriber line 24-1's aggregate distance metric at time T1 is 33, which includes an 18 mile distance between subscriber line 24-1 and subscriber line 24-4. Subscriber line 24-3's aggregate distance metric at time T1 is 29, which includes miles between subscriber line 24-3 and 24-4. However, after the de-assignment of subscriber line 24-4, the distances between subscriber lines 24-1/24-3 and 24-4 are obviated, and are therefore no longer accounted for when determining the aggregate distance metrics in the distance information 34B, leading to differences in rankings between distance information 34A and 34B.

Accordingly, FIGS. 3A and 3B collectively illustrate an example scenario that exemplifies the relative importance of re-evaluating the criterion(s) 32 after de-assignment of a first candidate subscriber line. Namely, if rankings of subscriber lines 24 for identification of candidate subscriber lines are only determined based on an initial evaluation of the criterion(s) 32, subsequent identification of candidate subscriber lines based on the initial rankings can be inaccurate, or less efficient.

FIG. 4 illustrates geolocation information that depicts a map of a geographic region for evaluation of a location criterion according to some implementations of the present disclosure. Specifically, geolocation information 36 depicts a map of a geographic region, and the locations of subscriber lines 24 within the geographic regions. As discussed with regards to FIG. 1, subscriber lines 24 can be grouped into location clusters 50 based on the geolocation information 36. The location clusters can be stored in subscriber line clustering information 38. For example, some portions of subscriber lines 24 can be grouped into location clusters 50-1, 50-2, and 50-3 based on their relative proximity to each other. Another portion of subscriber lines 24 that reside in the same building, or work in the same business, can be grouped together into location cluster 50-4.

In some implementations, the location clusters 50-1-50-4 can be ranked based on an aggregated bandwidth allocated to each location cluster 50. For example, the aggregate bandwidth allocated to location cluster 50-3 is 2, while the aggregate bandwidth allocated to location cluster 50-4 is 30. In some implementations, a location cluster 50 with a highest aggregate bandwidth allocation can be ranked first for collective identification as candidate subscriber line(s). Alternatively, in some implementations, the location cluster 50 with the lowest aggregate bandwidth allocation can be ranked first for collective identification as candidate subscriber line(s). Alternatively, in some implementations, the location clusters 50 may not be ranked within the subscriber line clustering information 38.

As described previously, it should be noted that subscriber lines 24 grouped into of a location cluster 50 are not necessarily bound together as a collective candidate subscriber line. For example, in some implementations, when evaluating the location criterion 32-2, the computing system 10 can instead merely assign the same value metric to each subscriber line within the location cluster 50.

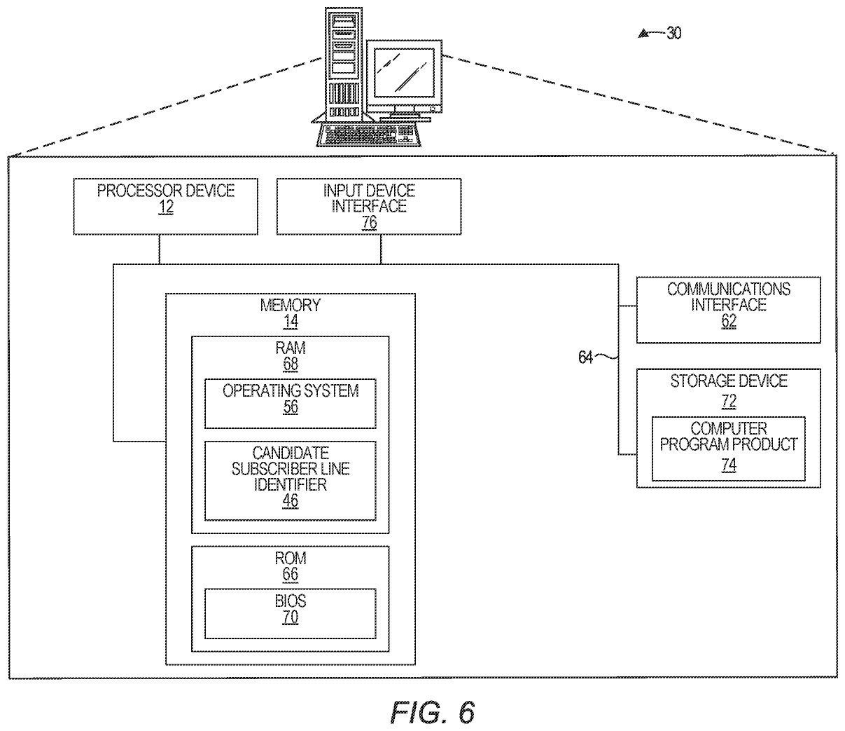

FIG. 5 illustrates infrastructure information that indicates additional network infrastructure for evaluation of an infrastructure criterion according to some implementations of the present disclosure. Specifically, FIG. 6 illustrates subscriber lines 24 served by network device 16. For example, subscriber lines 24-1, 24-2, 24-3, and 24-4 are all served by network device 16. Subscriber line 24-5 is also served by network device 16. As depicted, subscriber lines 24-1-24-4 are each 5 meters away from each other, and utilize a common piece of infrastructure 52 to carry the subscriber lines (e.g., an underground pipe, etc.). As each subscriber line 24-1-24-4 utilizes the same piece of infrastructure 52, they can each be considered as utilizing 5 meters of infrastructure each. Conversely, subscriber line 24-5 utilizes a piece of infrastructure 54 by itself. As the subscriber line 24-5 utilizes the piece of infrastructure 54 by itself, subscriber line 24-5 can be considered to utilize 15 meters of infrastructure.

Shared infrastructure utilization can be determined by the computing system 10 and can be stored in the infrastructure information 40. In some implementations, the subscriber lines 24 can be ranked according to shared infrastructure utilization. For example, in some implementations, as the subscriber line with the highest utilization of infrastructure, de-assigning subscriber line 24-5 from the network device 16 may reduce utilization of network infrastructure to a greater degree than any of subscriber lines 24-1-24-4. As such, subscriber line 24-5 may be ranked highest in the infrastructure information 40. Alternatively, in some implementations, subscriber line 24-5 may be ranked lowest in the infrastructure information 40.

FIG. 6 is a block diagram of the source computing system 10 suitable for implementing examples according to some implementations of the present disclosure. The source computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The source computing system 10 includes the processor device 12, the system memory 14, and a system bus 64. The system bus 64 provides an interface for system components including, but not limited to, the system memory 14 and the processor device 12. The processor device 12 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 14 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the source computing system 10. The volatile memory 68 may also include a high-speed RAM, such as static RAM, for caching data.

The source computing system 10 may further include or be coupled to a non-transitory computer-readable storage medium such as the storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system and one or more program modules, such as the candidate subscriber line identifier module 46, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device 12 to carry out the steps described herein. Thus, the computer-readable program code can comprise software instructions for implementing the functionality of the examples described herein when executed on the processor device 12. The processor device 12, in conjunction with the candidate subscriber line identifier module 46 in the volatile memory 68, may serve as a controller, or control system, for the source computing system 10 that is to implement the functionality described herein.

Because the candidate subscriber line identifier module 46 is a component of the computing system 10, functionality implemented by the candidate subscriber line identifier module 46 may be attributed to the computing system 10 generally. Moreover, in examples where the candidate subscriber line identifier module 46 comprises software instructions that program a processor device to carry out functionality discussed herein, functionality implemented by the candidate subscriber line identifier module 46 may be attributed herein to one or more processor devices 12 of the computer system 10.

Finally, it is noted that while, for purposes of illustration and simplicity, the embodiments are illustrated as being implemented by computer system that comprises a single computing device that in turn comprises a single processor device, in practice the examples/embodiments disclosed herein may be implemented in a computer system that comprises any number of computing devices, each of which may comprise one or more processor devices. Thus, irrespective of the implementation, the examples/embodiments may be implemented on a computer system that includes one or more computing devices, wherein the one or more computing devices comprise one or more processor devices, and the one or more processor devices are configured to implement functionality disclosed herein

An operator, such as a user, may also be able to enter one or more configuration commands through a keyboard (not illustrated), a pointing device such as a mouse (not illustrated), or a touch-sensitive surface such as a display device. Such input devices may be connected to the processor device 12 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like.

The source computing system 10 may also include the communications interface 62 suitable for communicating with the network(s) 18 as appropriate or desired. The source computing system 10 may also include a video port configured to interface with a display device to provide information to the user.

Individuals will recognize improvements and modifications to the preferred examples of the disclosure. All such improvements and modifications are considered within the scope of the concepts disclosed herein and the claims that follow.

What is claimed:

1. A method, comprising:
receiving, by a computing system comprising one or more processor devices, data indicative of a request to allocate an additional bandwidth amount to a subscriber line of a plurality of subscriber lines assigned to a network device;
determining, by the computing system, that a sum of the additional bandwidth amount and an aggregate bandwidth amount that is currently allocated to the plurality of subscriber lines exceeds a maximum bandwidth capacity of the network device;
evaluating at least one criterion to determine a value metric for each of the plurality of subscriber lines; and
identifying a candidate subscriber line of the plurality of subscriber lines to de-assign from the network device based at least in part on the value metric for the candidate subscriber line and a current bandwidth allocated to the candidate subscriber line.

2. The method of claim 1, wherein the method further comprises de-assigning the candidate subscriber line from the network device.

3. The method of claim 2, wherein the method further comprises modifying a bandwidth amount currently allocated to the subscriber line of the plurality of subscriber lines based on the additional bandwidth amount.

4. The method of claim 1, wherein the at least one criterion comprises a distance criterion, and wherein evaluating the distance criterion to determine the value metric for each of the plurality of subscriber lines comprises:
determining a distance between each of the plurality of subscriber lines; and
determining the value metric for each of the plurality of subscriber lines based at least in part on the distance between each of the plurality of subscriber lines.

5. The method of claim 4, wherein the candidate subscriber line comprises a subscriber line with a greatest distance between the subscriber line and the plurality of subscriber lines.

6. The method of claim 4, wherein the at least one criterion comprises a location criterion, and wherein evaluating the location criterion to determine the value metric for each of the plurality of subscriber lines comprises:
obtaining geolocation information descriptive of a location of each of the plurality of subscriber lines;
based on the geolocation information, grouping the plurality of subscriber lines into a plurality of location clusters; and
determining the value metric for each of the plurality of subscriber lines based at least in part on a bandwidth collectively allocated to each of the plurality of location clusters.

7. The method of claim 6, wherein identifying the candidate subscriber line of the plurality of subscriber lines comprises identifying a candidate location cluster of the plurality of location clusters to de-assign from the network device based at least in part on the value metric for each subscriber line of the candidate location cluster.

8. The method of claim 6, wherein the at least one criterion comprises an infrastructure criterion, and wherein evaluating the infrastructure criterion to determine the value metric for each of the plurality of subscriber lines comprises:
obtaining network infrastructure information descriptive of a quantity of network infrastructure shared between each of the plurality of subscriber lines; and
determining the value metric for each of the plurality of subscriber lines based at least in part on the network infrastructure information.

9. The method of claim 8, wherein the candidate subscriber line comprises a subscriber line with a lowest quantity of network infrastructure shared between the subscriber line and the plurality of subscriber lines.

10. The method of claim 8, wherein the at least one criterion comprises a plurality of criterions; and
evaluating the plurality of criterions to determine the value metric for each of the plurality of subscriber lines comprises:
applying weights to the plurality of criterions to obtain a plurality of weighted criterions; and
evaluating the plurality of weighted criterions to determine the value metric for each of the plurality of subscriber lines.

11. The method of claim 10, wherein, prior to applying the weights to the plurality of criterions, the method comprises determining the weights based on one or more of:
a population density of a geographic region that includes the network device;
a degree of infrastructure availability within a network that includes the network device; or
a current layout of subscriber lines within the network that includes the network device.

12. The method of claim 1, wherein the network device comprises a Cable Modem Termination System (CMTS)/Hybrid Fiber Coax (HFC) network port.

13. A computing system, comprising:
a memory; and
a processor device coupled to the memory to:
receive data indicative of a request to allocate an additional bandwidth amount to a subscriber line of a plurality of subscriber lines assigned to a network device;
determine that a sum of the additional bandwidth amount and an aggregate bandwidth amount that is currently allocated to the plurality of subscriber lines exceeds a maximum bandwidth capacity of the network device;
evaluate at least one criterion to determine a value metric for each of the plurality of subscriber lines; and
identify a candidate subscriber line of the plurality of subscriber lines to de-assign from the network device based at least in part on the value metric for the candidate subscriber line and a current bandwidth allocated to the candidate subscriber line.

14. The computing system of claim 13, wherein the processor device is further coupled to the memory to de-assign the candidate subscriber line from the network device.

15. The computing system of claim 14, wherein the processor device is further coupled to the memory to modify a bandwidth amount currently allocated to the subscriber line of the plurality of subscriber lines based on the additional bandwidth amount.

16. The computing system of claim 13, wherein the at least one criterion comprises a distance criterion, and wherein evaluating the distance criterion to determine the value metric for each of the plurality of subscriber lines comprises:
determining a distance between each of the plurality of subscriber lines; and
determining the value metric for each of the plurality of subscriber lines based at least in part on the distance between each of the plurality of subscriber lines.

17. The computing system of claim 16, wherein the candidate subscriber line comprises a subscriber line with a greatest distance between the subscriber line and the plurality of subscriber lines.

18. The computing system of claim 16, wherein the at least one criterion comprises a location criterion, and wherein evaluating the location criterion to determine the value metric for each of the plurality of subscriber lines comprises:
obtaining geolocation information descriptive of a location of each of the plurality of subscriber lines;
based on the geolocation information, grouping the plurality of subscriber lines into a plurality of location clusters; and
determining the value metric for each of the plurality of subscriber lines based at least in part on a bandwidth collectively allocated to each of the plurality of location clusters.

19. The computing system of claim 18, the at least one criterion comprises an infrastructure criterion, and wherein evaluating the infrastructure criterion to determine the value metric for each of the plurality of subscriber lines comprises:
obtaining network infrastructure information descriptive of a quantity of network infrastructure shared between each of the plurality of subscriber lines; and
determining the value metric for each of the plurality of subscriber lines based at least in part on the network infrastructure information.

20. A non-transitory computer-readable storage medium that includes executable instructions to cause one or more processor devices to:
receive data indicative of a request to allocate an additional bandwidth amount to a subscriber line of a plurality of subscriber lines assigned to a network device;
determine that a sum of the additional bandwidth amount and an aggregate bandwidth amount that is currently allocated to the plurality of subscriber lines exceeds a maximum bandwidth capacity of the network device;
evaluate at least one criterion to determine a value metric for each of the plurality of subscriber lines; and
identify a candidate subscriber line of the plurality of subscriber lines to de-assign from the network device based at least in part on the value metric for the candidate subscriber line and a current bandwidth allocated to the candidate subscriber line.
